(19) United States
(12) Patent Application Publication
(10) Pub. No.: US 2014/0354182 A1
(43) Pub. Date: Dec. 4, 2014

(54) PIXEL AND PIXEL CIRCUIT THEREOF

(71) Applicant: AU Optronics Corporation, HSIN-CHU (TW)

(72) Inventors: Li-Wei LIU, HSIN-CHU (TW); Wei-Chu HSU, HSIN-CHU (TW)

(73) Assignee: AU Optronics Corporation, HSIN-CHU (TW)

(21) Appl. No.: 14/160,878

(22) Filed: Jan. 22, 2014

(30) Foreign Application Priority Data
May 30, 2013 (TW) 102119130

(51) Int. Cl. G09G 3/32; H05B 33/08

(52) U.S. Cl. CPC G09G 3/3233; H05B 33/0842
USPC 315/307

(57) ABSTRACT

A pixel includes an organic light-emitting diode, a driving transistor, a first switch, a third switch and a fourth switch. The driving transistor is electrically coupled to the organic light-emitting diode. When the pixel is in a data writing period, the first switch is configured to write a data voltage into a control terminal of the driving transistor. When the pixel is in a compensating period, a path between a control terminal and a first terminal of the fourth switch is established to charge or discharge the control terminal of the driving transistor through a current path, thereby forming a compensating voltage according to the voltage of the control terminal of the driving transistor. The driving transistor is turned on by the compensating voltage during a light emitting period, and the third switch is turned on such that a driving current is provided to the organic light emitting diode.

### RELATED APPLICATIONS

This application claims priority to Taiwan Application Serial Number 102119130, filed May 30, 2013, which is herein incorporated by reference.

### BACKGROUND

1. Technical Field

The embodiment of the present invention relates generally to a basic electric circuit, and, more particularly, to a pixel and a pixel circuit thereof.

2. Description of Related Art

For display panels, to effectively control the light-emitting diode in a pixel, it is common to dispose a pixel circuit for this purpose; however, display panels using a pixel circuit suffer from various problems, such as transistor variation, IR drop, light-emitting diode aging, etc. Such problems result in uneven brightness of the display panel, thereby degrading the image quality of the display panel.

Although a compensating circuit may be arranged in the pixel to ameliorate the disadvantages associated with the above-mentioned problems, the disposition of a large quantity of transistors in the compensating circuit will result in a decrease in the aperture ratio of the pixel and in a reduced resolution.

In view of the foregoing, there remain disadvantages in the prior solutions that require further improvement. Although there has been much effort in trying to find a solution to the aforementioned problems, there is still a need to improve the existing apparatuses and techniques in the art.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

The present disclosure provides a pixel and a pixel circuit thereof which address the problems faced by the prior art.

One aspect of the present disclosure is directed to a pixel that comprises an organic light-emitting diode, a driving transistor, a first switch, a third switch and a fourth switch. The driving transistor is electrically coupled to the organic light-emitting diode. When the pixel is in a data writing period, the first switch is configured to write a data voltage into the control terminal of the driving transistor. When the pixel is in a compensating period, the fourth switch conducts the control terminal of the driving transistor and the first terminal, such that the control terminal of the driving transistor is charged and discharged via a current path, thereby forming a compensating voltage according to the voltage of the control terminal of the driving transistor. During a light emitting period, the compensating voltage conducts the driving transistor and turns on the third switch, such that the driving current is provided to the organic light-emitting diode.

Another aspect of the present disclosure is directed to a pixel circuit for driving a light-emitting diode. The pixel circuit comprises a first switch, a driving transistor, a third switch, a fourth switch and capacitor. Specifically, each of said driving transistor, first, third and fourth switches has a first terminal, a second terminal and a control terminal, while the capacitor has a first terminal. The first terminal of the first switch is electrically coupled to a data voltage, the control terminal of the driving transistor is electrically coupled to the second terminal of the first switch, the second terminal of the third switch is electrically coupled to the first terminal of the driving transistor, the first terminal of the fourth switch is electrically coupled to the second terminal of the first switch, the second terminal of the fourth switch is electrically coupled to the first terminal of the driving transistor, the first terminal of the capacitor is electrically coupled to the second terminal of the first switch.

Many of the attendant features and advantages of the present disclosure will become better understood with reference to the following detailed description considered in connection with the accompanying drawings.

### BRIEF DESCRIPTION OF THE DRAWINGS

The invention can be more fully understood by reading the following detailed description of the embodiments, with reference made to the accompanying drawings as follows:

FIG. 1A schematically shows a pixel according to one embodiment of the present invention;

FIG. 1B schematically shows a control waveform according to one embodiment of the present invention;

FIG. 2A schematically shows a pixel according to one embodiment of the present invention;

FIG. 2B schematically shows a control waveform according to one embodiment of the present invention;

FIG. 3A schematically shows a pixel according to one embodiment of the present invention; and

FIG. 3B schematically shows a control waveform according to one embodiment of the present invention.

FIG. 4A schematically shows a pixel according to one embodiment of the present invention.

FIG. 4B schematically shows a control waveform according to one embodiment of the present invention.

In accordance with common practice, the various described features/elements are not drawn to scale but instead are drawn to best illustrate specific features/elements relevant to the present invention. Also, like reference numerals and designations in the various drawings are used to indicate like elements/parts.

### DETAILED DESCRIPTION

The detailed description provided below in connection with the appended drawings is intended as a description of the present examples and is not intended to represent the only forms in which the present example may be constructed or utilized. The description sets forth the functions of the examples and the sequence of steps for constructing and operating the examples. However, the same or equivalent functions and sequences may be accomplished by different examples.

Unless otherwise defined herein, scientific and technical terminologies employed in the present disclosure shall have the meanings that are commonly understood and used by one of ordinary skill in the related art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise. The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

Further, as used herein, the terms “couple,” “coupling” and “coupled” mean two or more elements are electrically contacted with one another, either directly or indirectly; while the terms “connect,” “connecting” and “connected” mean two or more elements are physically contacted with one another, either directly or indirectly. All these terms may be used to indicate the mutual operation or action of two or more elements.

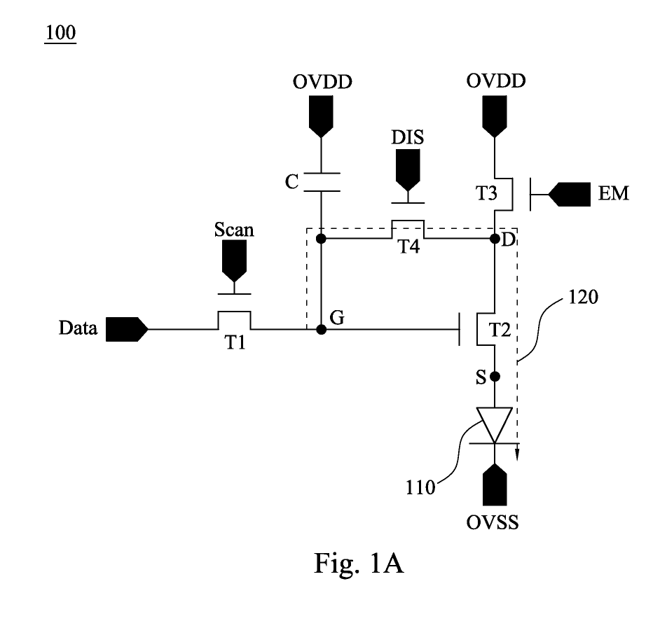

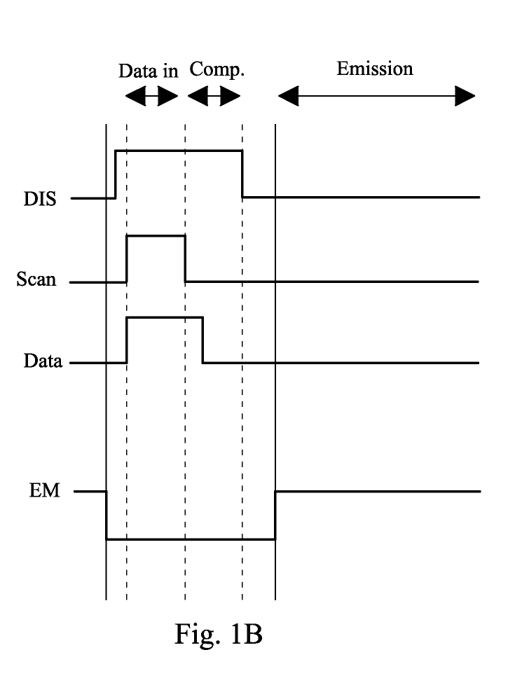

To address the problems existing in the prior art, the present disclosure provides a pixel structure, in conjunction with a three-stage control mode, so as to compensate for the voltage of a control terminal of a driving transistor in the pixel and thereby improve transistor variation, IR drop, and light-emitting diode aging. As a result, an improvement with respect to uneven brightness of the display panel is realized, and consequently, a high image quality of the display panel is maintained. The pixel structure is illustrated in FIGS. 1A, 2A and 3A, while the three-stage control mode is shown in FIGS. 1B, 2B and 3B. The following description, together with the drawings, is provided to explain the pixel structure and the three-stage control mode thereof.

As illustrated in FIG. 1A, the pixel 100 comprises a pixel circuit and an organic light-emitting diode 110. The pixel circuit comprises a first switch T1, a driving transistor T2, a third switch T3, a fourth switch T4 and a capacitor C. Each of the driving transistor T2, and the first, third and fourth switches (T1, T3 and T4) has a first terminal, a second terminal and a control terminal, while the capacitor C has a first terminal and a second terminal. With respect to the interconnections among and the application of signals to these elements, the first terminal of the first switch T1 is electrically coupled to a data voltage Data, the control terminal of the driving transistor (or namely the second switch) T2 is directly connected to the second terminal of the first switch T1, the second terminal of the third switch T3 is directly connected to the first terminal of the driving transistor T2, the first terminal of the fourth switch T4 is directly connected to the second terminal of the first switch T1, the second terminal of the fourth switch T4 is directly connected to the first terminal of the driving transistor T2, the first terminal (or namely the first electrode) of the capacitor C is directly connected to the second terminal of the first switch T1, and the second terminal (or namely the second electrode) of the capacitor C is electrically coupled to a power source OVDD. It should be noted that the second terminal of the fourth switch T4, in addition to being directly connected to the first terminal of the driving transistor T2, is also directly connected to the second terminal of the third switch T3; that is, the second terminal of the fourth switch T4 is directly connected to the first terminal of the driving transistor T2 and the second terminal of the third switch T3. The first terminal of the capacitor C, in addition to being directly connected to the second terminal of the first switch T1, is also directly connected to the first terminal of the fourth switch T4 and the control terminal of the driving transistor T2; that is, the first terminal of the capacitor C is directly connected to the second terminal of the first switch T1, the first terminal of the fourth switch T4 and the control terminal of the driving transistor T2.

In operation, the first switch T1 is controlled by a scan signal Scan, the driving transistor T2 is controlled by a data voltage Data via the first switch T1, the third switch (or namely the power source control switch) T3 is controlled by an emitting signal EM, and the fourth switch T4 is controlled by a discharging signal DIS.

For the implementation of the embodiments of the present disclosure, each of the driving transistor and switches can be a bipolar junction transistor (BJT), field-effect transistor (FET), insulated gate bipolar transistor (IGBT), etc., but the present disclosure is not limited in this regard. Persons having ordinary skill in the art may, in accordance with the spirit of the embodiments of the present disclosure, flexibly select suitable components to implement the present disclosure depending on actual need(s).

Referring back to FIG. 1A, when the driving transistor and switches are field-effect transistors, in particular, N-type thin-film transistors (TFTs), the second terminal of the driving transistor T2 is directly connected to the anode of the light-emitting diode 110, the cathode of the light-emitting diode 110 is electrically connected to a reference voltage terminal OVSS, and the first terminal of the third switch T3 is electrically connected to a power source OVDD.

Next, the three-stage control mode of the pixel 100 is discussed. To facilitate the understanding of the overall control mode, reference is made to FIGS. 1A and 1B concurrently, in which FIG. 1B schematically shows a control waveform according to one embodiment of the present invention.

First, when the pixel 100 is in a data writing period (Data in), the scan signal Scan is a high-level signal, and therefore the first switch T1 is turned on. Hence, the first switch T1 writes the data voltage Data into the control terminal of the driving transistor T2. At this time, the voltage of the control terminal of the driving transistor T2 is the data voltage Data. Moreover, the discharging signal DIS is also a high-level signal, and therefore, the fourth switch T4 is turned on. On the other hand, the emitting signal EM is a low-level signal, and the third switch T3 remains turned off. In this embodiment, before the first switch T1 is turned on, the fourth switch T4 has been turned on already. However, the present disclosure is not limited in this regard; that is, the first switch T1 and the fourth switch T4 may be turned on simultaneously.

Next, when the pixel 100 is in a compensating period (Comp.), the scan signal Scan is a low-level voltage while the discharging signal DIS is still a high-level signal, and hence the first switch T1 is turned off while the fourth switch T4 is turned on, thereby conducting the control terminal G of the driving transistor T2 and the first terminal D. At this time, the driving transistor T2 acts like a diode, thereby forming a current path 120, such that the data voltage Data of the control terminal of the driving transistor T2 is discharged via the current path 120, so that the data voltage Data of the control terminal of the driving transistor T2 is discharged with a potential difference ΔV, thereby forming a compensating voltage (V_{Data}−ΔV). At this time, the emitting signal EM is still a low-level signal, and hence the third switch T3 is still turned off.

Moreover, when the pixel 100 is in a light emitting period (Emission), the emitting signal EM is a high-level signal and the discharging signal DIS is a low-level signal, such that the third switch T3 is correspondingly turned on while the fourth switch T4 is correspondingly turned off. The scan signal Scan and data voltage Data are both low-level signals, and therefore the first switch T1 is turned off. Moreover, the compensating voltage (V_{Data}−ΔV) conducts the driving transistor T2, and hence the driving current is provided to the organic light-emitting diode 110 via the driving transistor T2. In the present embodiment, the third switch T3 is turned on after the fourth switch T4 has been turned off; however, the present disclosure is not limited in this regard, and the turning off of the fourth switch T4 and the turning on of the third switch T3 may happen at the same time.

The pixel characteristics according to embodiments of the present disclosure are discussed with reference to the current formula for the thin-film transistor, which is as follows:

$${I}_{DS} = \frac{1}{2} μ {C}_{OX} ( \frac{W}{L} ) {( {V}_{GS} - {V}_{th} )}^{2} \qquad ( 1 )$$

When the pixel 100 is in a compensating period (Comp.), the data voltage Data of the control terminal of the driving transistor T2 is discharged with a potential difference ΔV, thereby forming a compensating voltage (V_{Data}−ΔV). At this time, the V_{GS} of the driving transistor T2 is equal to V_{Data}−ΔV−V_{OLED}−V_{OVSS}. Next, the V_{GS} of the driving transistor T2 is substituted into formula (1) to obtain the following formula:

$${I}_{DS} = \frac{1}{2} μ {C}_{OX} ( \frac{W}{L} ) {( {V}_{data} - Δ V - {V}_{OLED} - {V}_{OVSS} - {V}_{th} )}^{2} \qquad ( 2 )$$

In conclusion, when each element parameter varies, the compensating voltage may be automatically adjusted such that the driving current I_{OLED} is maintained in a stable state, and the driving current I_{OLED} is equal to the OLED emitting current. Accordingly, even when the pixel 100 encounters adverse conditions such as transistor variation, IR drop, light-emitting diode aging, etc., the driving current I_{OLED} may be stably maintained, which in turn improves the evenness of the brightness for the display panel to thereby enhance the image quality of the display panel. Moreover, since the pixel 100 is only disposed with one driving transistor and three switches, the problems of low pixel aperture ratio and limited resolution associated with a large quantity of transistors disposed in the compensating circuit are ameliorated.

For example, the compensating mechanism of the pixel circuit is such that when the circuit is operated in the compensating period (Comp.), the relationship between the level of the discharging potential difference ΔV and the level of the discharging amperage of the current path 120 is used to allow the automatic adjustment of the compensating voltage (V_{Data}−ΔV). The detailed adjustment process is as follows: the control terminal of the driving transistor T2 discharges the reference voltage terminal OVSS with a potential difference ΔV via the current path 120, thereby forming the compensating voltage (V_{Data}−ΔV). Since the potential difference ΔV is in direct proportion to the level of the discharging amperage, the amperage level is related to the threshold voltage Vₜₕ of the driving transistor T2, the mobility μ of the driving transistor T2, the voltage of the reference voltage terminal OVSS and the voltage of the OLED. Therefore, in a state where the conduction duration of the fourth switch T4 is fixed, the compensating voltage (V_{Data}−ΔV) is automatically adjusted corresponding to the variation level of each factor.

In one embodiment, with reference to formula (2), when the mobility μ of the driving transistor T2 increases, the discharging current increases accordingly; that is, the potential difference ΔV increases, such that the driving current I_{OLED} is maintained in a stable state. In another embodiment, with reference to formula (2), when the threshold voltage Vₜₕ of the driving transistor T2 increases, the discharging current decreases accordingly; that is, the potential difference ΔV decreases, such that the driving current I_{OLED} is maintained in a stable state.

In still another embodiment, with reference to formula (2), when the voltage drop V_{OLED} of the organic light-emitting diode increases, the discharging current decreases accordingly; that is, the potential difference ΔV decreases, such that the driving current I_{OLED} is maintained in a stable state.

In yet another embodiment, with reference to formula (2), when the reference voltage V_{OVSS} of the reference voltage terminal OVSS increases, the discharging current decreases accordingly; that is, the potential difference ΔV decreases, such that the driving current I_{OLED} is maintained in a stable state.

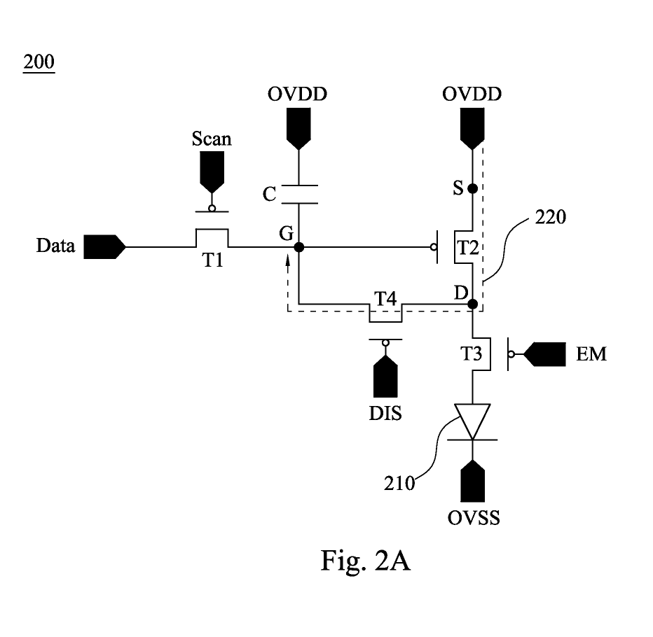

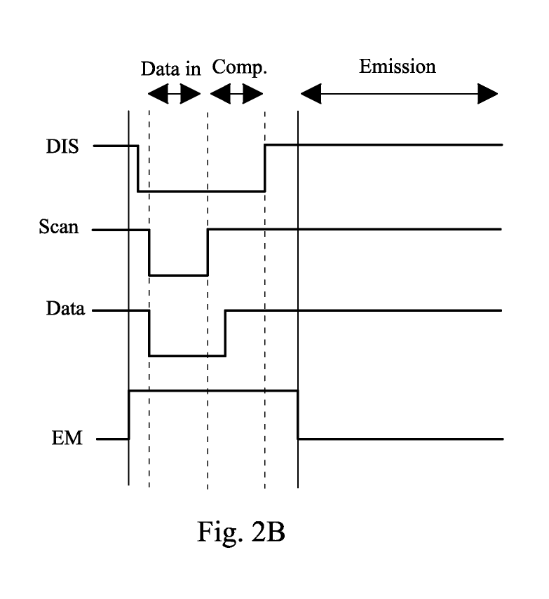

Next, the second implementation of the pixel circuit structure, with reference to FIG. 2A, differs from the first implementation in that the driving transistor and switches are field-effect transistors, and in particular, P-type thin-film transistors (TFTs). Specifically, the control terminal of the first switch T1 is electrically connected to a scan signal Scan, the first terminal of the first switch T1 is electrically connected to a data voltage Data, the first terminal of the driving switch (or namely the second switch) T2 is electrically connected to the power source OVDD, the control terminal of the third switch (or the power source control switch) T3 is electrically connected to the emitting signal EM, the first terminal of the third switch T3 is directly connected to the anode of the light-emitting diode 210, the control terminal of the fourth switch T4 is electrically connected to the discharging signal DIS, the first terminal of the fourth switch T4 is directly connected to the first terminal of the driving switch T2 and the second terminal of the third switch T3, the second terminal of the capacitor C is electrically connected to the power source OVDD, the first terminal of the capacitor C is directly connected to the second terminal of the first switch T1, the control terminal of the driving switch T2 and the second terminal of the fourth switch T4, and the cathode of the light-emitting diode 210 is electrically connected to reference voltage source OVSS.

Reference is now made to FIG. 2B which illustrates a control waveform according to one embodiment of the present invention. First, when the pixel 200 is in a data writing period (Data in), the scan signal Scan and the data voltage Data are both low-level signals, and hence the first switch T1 is turned on. Therefore, the first switch T1 writes the data voltage Data into the control terminal G of the driving transistor T2. At this time, the voltage of the control terminal G of the driving transistor T2 is the data voltage Data. Moreover, the discharging signal DIS is a low-level signal, and hence the fourth switch T4 is turned on. However, the emitting signal EM is a high-level signal, and as a result, the third switch T3 is still turned off. In the present embodiment, the fourth switch T4 is turned on before the first switch T1 is turned on. However, the present disclosure is not limited in this regard; that is, the first switch T1 and fourth switch T4 can be turned on concurrently.

Secondly, when the pixel 200 is in a compensating period (Comp.), the scan signal Scan and the data voltage Data are both high-level voltages, and hence the first switch T1 is turned off. Additionally, the discharging signal DIS is still a low-level signal, and therefore, the fourth switch T4 is turned on, thereby conducting the control terminal G of the driving transistor T2 and the first terminal D. Moreover, the emitting signal EM is still a high-level signal, such that the third switch T3 is still turned off. At this time, the driving transistor T2 acts like a diode, thereby forming a current path 220, such that the control terminal of the driving transistor T2 is charged via the current path 220. As a result, the power source OVDD charges the data voltage Data of the control terminal of the driving transistor T2, such that the data voltage Data of the control terminal of the driving transistor T2 is increased by a potential difference ΔV, thereby forming the compensating voltage (V_{Data}+ΔV), wherein the potential difference ΔV is in direct proportion to the charging current level.

Furthermore, when the pixel 200 is in a light emitting period (Emission), the emitting signal EM is a low-level signal, and the discharging signal DIS is a high-level signal, and hence the third switch T3 is correspondingly turned on, and the fourth switch T4 is correspondingly turned off. Moreover, the scan signal Scan and the data voltage Data are both high-level voltages, and hence the first switch T1 is still turned off. In the present embodiment, the third switch T3 is turned on after the fourth switch T4 has been turned off. However, the present disclosure is not limited in this regard; that is, the turning off of the fourth switch T4 and the turning on of the third switch T3 may happen simultaneously. At this time, the compensating voltage (V_{Data}+ΔV) conducts the driving transistor T2, and hence, the driving current is provided to the organic light-emitting diode 210 via the driving transistor T2.

The characteristics of the pixel 200 according to the present embodiment are discussed with reference to the current formula of the thin-film transistor, which is as follows:

$${I}_{DS} = \frac{1}{2} μ {C}_{OX} ( \frac{W}{L} ) {( {V}_{SG} - {V}_{th} )}^{2} \qquad ( 3 )$$

When the pixel 200 is in a compensating period (Comp.), the data voltage Data of the control terminal G of the driving transistor T2 is increased by a potential difference ΔV, thereby forming the compensating voltage (V_{Data}+ΔV). Next, during a light emitting period (Emission), the V_{SG} of the driving transistor T2 is equal to V_{OVDD}−V_{Data}−ΔV. Subsequently, the V_{SG} of the driving transistor T2 is substituted into formula (3), thereby obtaining the following formula:

$${I}_{DS} = \frac{1}{2} μ {C}_{OX} ( \frac{W}{L} ) {( {V}_{OVDD} - {V}_{Data} - Δ V - {V}_{th} )}^{2} \qquad ( 4 )$$

In conclusion, when each element parameter varies, the compensating voltage can be automatically adjusted such that the driving current I_{OLED} is maintained in a stable state.

For example, the compensating mechanism of the pixel circuit is such that when the circuit is operated in the compensating period (Comp.), the relationship between the level of the charging potential difference ΔV and the level of the charging amperage of the current path 220 is used to allow the automatic adjustment of the compensating voltage (V_{Data}+ΔV). The detailed adjustment process is as follows: the power source OVDD charges the control terminal of the driving transistor T2 with a potential difference ΔV via the current path 220, thereby forming the compensating voltage (V_{Data}+ΔV). Since the potential difference ΔV is in direct proportion to the level of the charging amperage of the current path 220, the amperage level is related to the threshold voltage Vₜₕ of the driving transistor T2, the mobility μ of the driving transistor T2, and the voltage of the power source OVDD. Therefore, under the condition that the conduction duration of the fourth switch T4 is fixed, the compensating voltage (V_{Data}+ΔV) is automatically adjusted corresponding to the variation level of each factor.

In one embodiment, with reference to formula (4), when the mobility μ of the driving transistor T2 increases, the charging current increases accordingly; that is, the potential difference ΔV increases, such that the driving current I_{OLED} is maintained in a stable state.

In another embodiment, with reference to formula (4), when the threshold voltage Vₜₕ of the driving transistor T2 increases, the charging current decreases accordingly; that is, the potential difference ΔV decreases, such that the driving current I_{OLED} is maintained in a stable state.

In still another embodiment, with reference to formula (4), when the voltage provided by the power source OVDD decreases, the charging current decreases accordingly; that is, the potential difference ΔV decreases, such that the driving current I_{OLED} is maintained in a stable state.

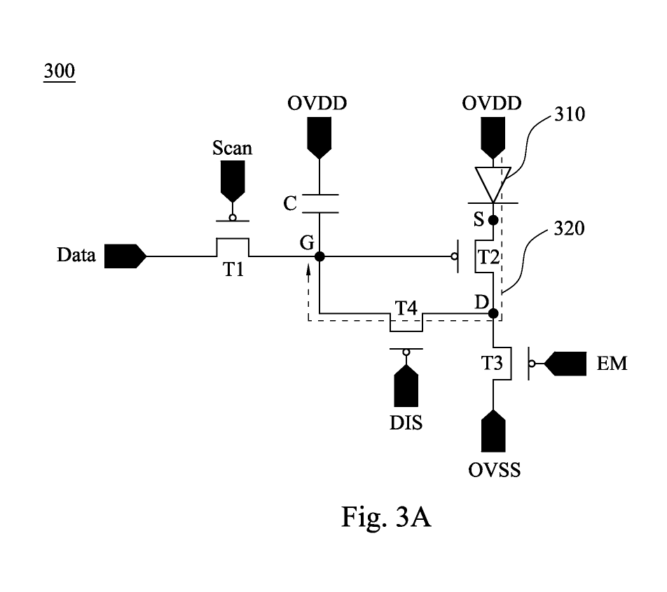

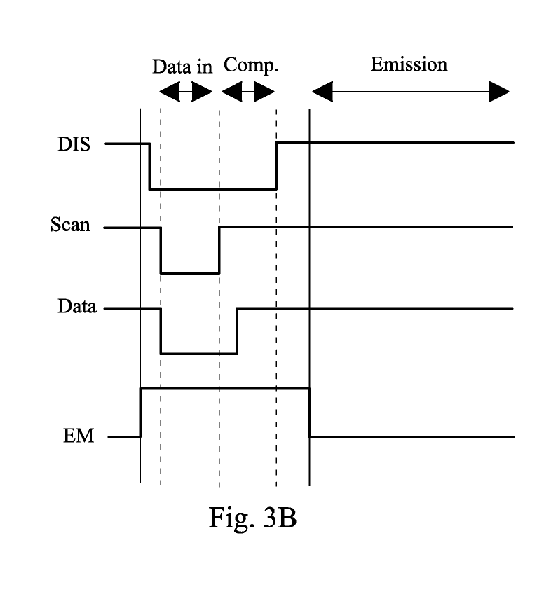

Moreover, the third implementation of the pixel circuit structure, with reference to FIG. 3A, differs from the first implementation in that the driving transistor and switches are field-effect transistors, in particular, P-type thin-film transistors (TFTs), the second terminal of the driving transistor T2 is directly connected to the cathode of the light-emitting diode 310, and the first terminal of the third switch T3 is electrically connected to the reference voltage terminal OVSS. Specifically, the control terminal of the first switch T1 is electrically connected to a scan signal Scan, the first terminal of the first switch T1 is electrically connected to a data voltage Data, the second terminal of the driving switch (or namely the second switch) T2 is directly connected to the cathode of the light-emitting diode 310, the control terminal of the third switch (or the power source control switch) T3 is electrically connected to an emitting signal EM, the first terminal of the third switch T3 is electrically connected to a reference voltage source OVSS, the control terminal of the fourth switch T4 is electrically connected to a discharging signal DIS, the first terminal of the fourth switch T4 is directly connected to the first terminal of the driving switch T2 and the second terminal of the third switch T3, the second terminal of the capacitor C is electrically connected to power source OVDD, the first terminal of the capacitor C is directly connected to the second terminal of the first switch T1, the control terminal of the driving switch T2 and the second terminal of the fourth switch T4, and the anode of the light-emitting diode 310 is electrically connected to the power source OVDD.

Reference is now made to FIG. 3B which illustrates a control waveform according to one embodiment of the present invention. First, when the pixel 300 is in a data writing period (Data in), the scan signal Scan and the data voltage Data are both low-level signals, and hence the first switch T1 is turned on. Therefore, the first switch T1 writes the data voltage Data into the control terminal G of the driving transistor T2. At this time, the voltage of the control terminal G of the driving transistor T2 is the data voltage Data. Moreover, the discharging signal DIS is a low-level signal, and hence the fourth switch T4 is turned on. However, the emitting signal EM is a high-level signal, and as a result, the third switch T3 is still turned off. In the present embodiment, the fourth switch T4 is turned on before the first switch T1 is turned on. However, the present disclosure is not limited in this regard; that is, the first switch T1 and fourth switch T4 can be turned on concurrently.

Secondly, when the pixel 300 is in a compensating period (Comp.), the scan signal Scan and the data voltage Data are both high-level voltages, and hence the first switch T1 is turned off. Additionally, the discharging signal DIS is still a low-level signal, and therefore, the fourth switch T4 is turned on, thereby conducting the control terminal G of the driving transistor T2 and the first terminal D. Moreover, the emitting signal EM is still a high-level signal, such that the third switch T3 is still turned off. At this time, the driving transistor T2 acts like a diode, thereby forming a current path 320, such that the power source OVDD charges the control terminal G of the driving transistor T2 via the current path 320. As a result, the power source OVDD charges the data voltage Data of the control terminal of the driving transistor T2, such that the data voltage Data of the control terminal G of the driving transistor T2 is increased by a potential difference ΔV, thereby forming the compensating voltage (V_{Data}+ΔV).

Furthermore, when the pixel 300 is in a light emitting period (Emission), the emitting signal EM is a low-level signal, and hence the third switch T3 is correspondingly is turned on, while the discharging signal DIS is a high-level signal, and hence the fourth switch T4 is correspondingly turned off. Moreover, the scan signal Scan and the data voltage Data are both high-level voltages, and hence the first switch T1 is still turned off. At this time, the compensating voltage (V_{Data}+ΔV) conducts the driving transistor T2, and hence, the driving current is provided to the organic light-emitting diode 310 via the driving transistor T2. In the present embodiment, the third switch T3 is turned on after the fourth switch T4 has been turned off. However, the present disclosure is not limited in this regard; that is, the turning off of the fourth switch T4 and the turning on of the third switch T3 may happen simultaneously.

The characteristics of the pixel 300 according to the present embodiment are discussed with reference to the current formula of the thin-film transistor. Said current formula is the same as the formula (3) described hereinabove, and hence, will not be recreated below.

When the pixel 300 is in a compensating period (Comp.), the data voltage Data of the control terminal of the driving transistor T2 is increased by a potential difference ΔV, thereby forming the compensating voltage (V_{Data}+ΔV). Next, during a light emitting period (Emission), the V_{SG} of the driving transistor T2 is equal V_{OVDD}−V_{OLED}−V_{Data}−ΔV. Subsequently, the V_{SG} of the driving transistor T2 is substituted into formula (3), thereby obtaining the following formula:

$${I}_{DS} = \frac{1}{2} μ {C}_{OX} ( \frac{W}{L} ) {( {V}_{OVDD} - {V}_{OLED} - {V}_{Data} - Δ V - {V}_{th} )}^{2} \qquad ( 5 )$$

In conclusion, when each element parameter varies, the compensating voltage can be automatically adjusted such that the driving current I_{OLED} is maintained in a stable state.

For example, the compensating mechanism of the pixel circuit is such that when the circuit is operated in the compensating period (Comp.), the relationship between the level of the charging potential difference ΔV and the level of the charging amperage of the current path 320 is used to allow the automatic adjustment of the compensating voltage. The detailed adjustment process is as follows: the power source OVDD charges the control terminal of the driving transistor T2 with a potential difference ΔV via the current path 320, thereby forming the compensating voltage (V_{Data}+ΔV). Since the potential difference ΔV is in direct proportion to the level of the charging amperage, the amperage level is related to the threshold voltage Vₜₕ of the driving transistor, the mobility μ of the driving transistor, the voltage of the power source OVDD and the voltage of the OLED. Therefore, under the condition that the conduction duration of the fourth switch T4 is fixed, the compensating voltage (V_{Data}+ΔV) is automatically adjusted corresponding to the variation level of each factor.

In one embodiment, with reference to formula (5), when the mobility μ of the driving transistor T2 increases, the charging current increases accordingly; that is, the potential difference ΔV increases, such that the driving current I_{OLED} is maintained in a stable state.

In another embodiment, with reference to formula (5), when the threshold voltage Vₜₕ of the driving transistor T2 increases, the charging current decreases accordingly; that is, the potential difference ΔV decreases, such that the driving current I_{OLED} is maintained in a stable state.

In still another embodiment, with reference to formula (5), when the voltage provided by the power source OVDD decreases, the charging current decreases accordingly; that is, the potential difference ΔV decreases, such that the driving current I_{OLED} is maintained in a stable state.

In yet another embodiment, with reference to formula (5), when the voltage drop V_{OLED} of the organic light-emitting diode increases, the charging current decreases accordingly; that is, the potential difference ΔV decreases, such that the driving current I_{OLED} is maintained in a stable state.

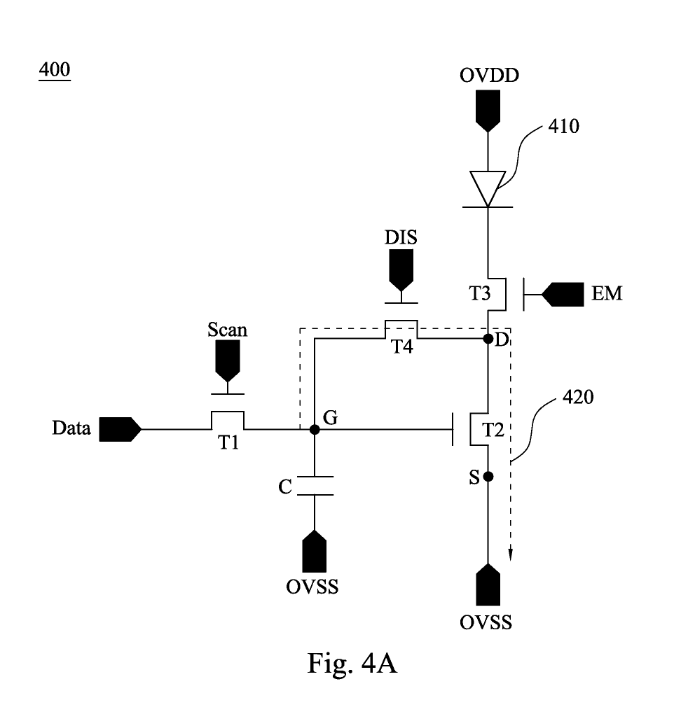

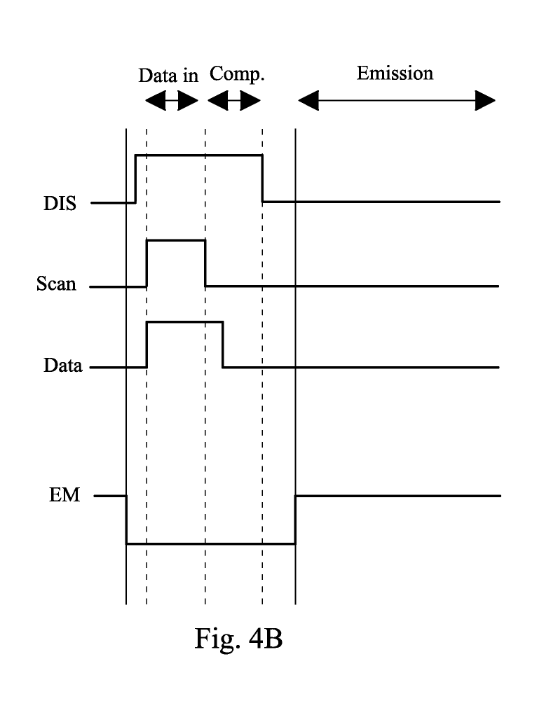

FIG. 4A schematically shows a pixel according to one embodiment of the present invention. Compared with the pixel 100 in FIG. 1A, the second terminal of the capacitor C of the pixel 400 in FIG. 4A is electrically coupled to the reference voltage terminal OVSS. In addition, the anode of the organic light-emitting diode 410 in FIG. 4A is electrically connected to the power source OVDD, and the cathode of the light-emitting diode 410 is electrically connected to the first terminal of the third switch T3.

Reference is now made to FIG. 4B which illustrates a control waveform according to one embodiment of the present invention. As illustrated in FIG. 4B, the control waveform herein is identical to the control waveform in FIG. 1 B. Accordingly, the operations of the pixel 400 in FIG. 4A are similar to that of the pixel 100 in FIG. 1A. Specifically, in the compensating period (Comp.), a current path 420 is also formed in the pixel 400. Subsequently, the data voltage Data of the control terminal of the driving transistor T2 is discharged via the current path 420, so that the data voltage Data of the control terminal of the driving transistor T2 is discharged with a potential difference ΔV, thereby forming a compensating voltage (V_{Data}−ΔV).

In conclusion, when each element parameter varies, the compensating voltage (V_{Data}−ΔV) may be automatically adjusted such that the driving current I_{OLED} is maintained in a stable state. Accordingly, even when the pixel 400 as illustrated in FIG. 4A encounters adverse conditions such as transistor variation, IR drop, light-emitting diode aging, etc., the driving current I_{OLED} may be stably maintained, which in turn improves the evenness of the brightness for the display panel to thereby enhance the image quality of the display panel. Moreover, since the pixel 400 is only disposed with one driving transistor and three switches, the problems of low pixel aperture ratio and limited resolution associated with a large quantity of transistors disposed in the compensating circuit are ameliorated.

In view of the foregoing embodiments of the present disclosure, it is appreciated that the application of the present disclosure achieves a number of advantages. Embodiments of the present disclosure provide a pixel and pixel circuit to address the problems of uneven brightness and poor quality of the display panel that are associated with transistor variation, IR drop, light-emitting diode aging, etc. Further, since the pixel is only disposed with one driving transistor and three switches, the problems of low pixel aperture ratio and limited resolution associated with a large quantity of transistors disposed in the compensating circuit are ameliorated.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A pixel, comprising:
an organic light-emitting diode;
a driving transistor electrically coupled to the organic light-emitting diode;
a first switch, wherein when the pixel is in a data writing period, the first switch is configured to write a data voltage into the control terminal of the driving transistor;
a fourth switch, wherein when the pixel is in a compensating period, the fourth switch conducts the control terminal of the driving transistor and a first terminal, such that the control terminal of the driving transistor is charged and discharged via a current path, thereby forming a compensating voltage according to the voltage of the control terminal of the driving transistor; and
a third switch, wherein during a light emitting period, the compensating voltage conducts the driving transistor and turns on the third switch, such that a driving current is provided to the organic light-emitting diode.

2. The pixel according to claim 1, wherein when each element parameter of the pixel varies, the compensating voltage is correspondingly adjusted such that the driving current is maintained in a stable state.

3. The pixel according to claim 2, wherein during the compensating period, the amperage level of the current path varies depending on the variation of the element parameter, such that the compensating voltage is correspondingly adjusted.

4. The pixel according to claim 1, wherein when the mobility of the driving transistor increases, the compensating voltage is correspondingly lowered such that the driving current is maintained in a stable state.

5. The pixel according to claim 2, wherein when the mobility of the driving transistor increases, the compensating voltage is correspondingly lowered such that the driving current is maintained in a stable state.

6. The pixel according to claim 3, wherein when the mobility of the driving transistor increases, the compensating voltage is correspondingly lowered such that the driving current is maintained in a stable state.

7. The pixel according to claim 1, wherein when the threshold voltage of the driving transistor increases, the voltage provided by the power source OVDD decreases, the reference voltage provided by the reference voltage terminal OVSS increases, or the voltage drop of the organic light-emitting diode increases, the compensating voltage is correspondingly elevated such that the driving current is maintained in a stable state.

8. The pixel according to claim 2, wherein when the threshold voltage of the driving transistor increases, the voltage provided by the power source OVDD decreases, the reference voltage provided by the reference voltage terminal OVSS increases, or the voltage drop of the organic light-emitting diode increases, the compensating voltage is correspondingly elevated such that the driving current is maintained in a stable state.

9. The pixel according to claim 3, wherein when the threshold voltage of the driving transistor increases, the voltage provided by the power source OVDD decreases, the reference voltage provided by the reference voltage terminal OVSS increases, or the voltage drop of the organic light-emitting diode increases, the compensating voltage is correspondingly elevated such that the driving current is maintained in a stable state.

10. The pixel according to claim 1, wherein the control terminal of the driving transistor discharges a reference voltage terminal OVSS by a potential difference via the current path, and the potential difference is in direct proportion to a discharging current level, wherein the compensating voltage is equal to the data voltage minus the potential difference.

11. The pixel according to claim 1, wherein a power source OVDD charges the control terminal of the driving transistor by a potential difference via the current path, and the potential difference is in direct proportion to a charging current level, wherein the compensating voltage is equal to the sum of the data voltage and the potential difference.

12. A pixel circuit for driving a light-emitting diode, the pixel circuit comprising:
a first switch having a first terminal, a second terminal and a control terminal, wherein the first terminal of the first switch is electrically coupled to a data voltage;
a driving transistor having a first terminal, a second terminal and a control terminal, wherein the control terminal of the driving transistor is electrically coupled to the second terminal of the first switch;
a third switch having a first terminal, a second terminal and a control terminal, wherein the second terminal of the third switch is electrically coupled to the first terminal of the driving transistor;
a fourth switch having a first terminal, a second terminal and a control terminal, wherein the first terminal of the fourth switch is electrically coupled to the second terminal of the first switch, and the second terminal of the fourth switch is electrically coupled to the first terminal of the driving transistor; and
a capacitor having a first terminal, wherein the first terminal of the capacitor is electrically coupled to the second terminal of the first switch.

13. The pixel circuit according to claim 12, wherein the capacitor has a second terminal, and the second terminal of the capacitor is electrically coupled to a power source.

14. The pixel circuit according to claim 12, wherein the capacitor has a second terminal, and the second terminal of the capacitor is electrically coupled to a reference voltage terminal.

15. The pixel circuit according to claim 12, wherein the second terminal of the driving transistor is electrically coupled to a reference voltage terminal OVSS.

16. The pixel circuit according to claim 15, wherein the first terminal of the third transistor is electrically coupled to the light-emitting diode.

17. The pixel circuit according to claim 12, wherein the first switch, the driving transistor, the third switch and the fourth switch are N-type transistors, the second terminal of the driving transistor is electrically connected to the anode of the light-emitting diode, and the first terminal of the third switch is electrically connected to the power source OVDD.

18. The pixel circuit according to claim 12, wherein the first switch, the driving transistor, the third switch and fourth switch are P-type transistors, the second terminal of the driving transistor is electrically connected to the power source OVDD, and the first terminal of the third switch is electrically connected to the anode of the light-emitting diode.

19. The pixel circuit according to claim 12, wherein the first switch, the driving transistor, the third switch and the fourth switch are P-type transistors, the second terminal of the driving transistor is electrically connected to the cathode of the light-emitting diode, and the first terminal of the third switch is electrically connected to a reference voltage terminal OVSS.

20. The pixel circuit according to claim 12, wherein, in a data writing period, the first switch writes a data voltage into the control terminal of the driving transistor; in a compensating period, the fourth switch conducts the control terminal of the driving transistor and the first terminal, such that the control terminal of the driving transistor is charged and discharged via a current path, thereby forming a compensating voltage according to the voltage of the control terminal of the driving transistor; and during a light emitting period, the compensating voltage conducts the driving transistor, such that a driving current is provided to the light-emitting diode.
